(19) United States
(12) Patent Application Publication
(10) Pub. No.: US 2025/0116785 A1
(43) Pub. Date: Apr. 10, 2025

(54) Detecting and Correcting for Location Drift in PNT Systems

(71) Applicant: Astra Navigation, Inc., Escondido, CA (US)

(72) Inventors: Alexandre Toutov, Kingston (CA); Anton Toutov, Magnolia, TX (US); Oleksiy Lutsyk, Inowroclaw (PL); Svitlana Ilnytska, Kingston (CA); Maryna Mukhina, Warsaw (PL)

(73) Assignee: Astra Navigation, Inc., Escondido, CA (US)

(21) Appl. No.: 18/902,674

(22) Filed: Sep. 30, 2024

Related U.S. Application Data
(60) Provisional application No. 63/542,292, filed on Oct. 4, 2023.

(51) Int. Cl. G01S 19/47; G01S 19/21

(52) U.S. Cl. CPC G01S 19/47; G01S 19/215

(57) ABSTRACT

In one embodiment, a method includes accessing a series of magnetic values measured by a magnetic-measurement device over a predetermined period of time. Each of the magnetic values corresponds to a location of the magnetic-measurement device during the predetermined period of time. The method includes, based on the series of magnetic values, determining that the location or orientation of the magnetic-measurement device did not substantially change during the predetermined period of time.

### PRIORITY

This application claims the benefit, under 35 U.S.C. § 119 (e), of U.S. Provisional Patent Application No. 63/542,292, filed 4 Oct. 2023, which is incorporated herein by reference in its entirety for all purposes.

### TECHNICAL FIELD

This disclosure generally relates to magnetic navigation and localization.

### BACKGROUND

A Global Navigation Satellite System (GNSS) is a network of satellites that can be used to produce position, navigation, and time (PNT) data sets. The Global Positioning System (GPS) is a widely used form of GNSS. Regional applications of such systems are also used to generate more regionally specific PNT data. For example, Galileo can be used in Europe; GLONASS can be used in Russia; and the BeiDou Navigation Satellite System (BDS) can be used in China.

GNSSs can have failure points. For example, some GNSSs lose reliability when operated inside buildings or in areas where network communication to the device is intermittent. Some GNSSs lose reliability when operated in dense city environments where large buildings interfere with communication signals. Some GNSSs lose reliability when operated in areas such as caves, tunnels, and mountains that impede location devices' reception of signals from GNSS satellites. Moreover, some GNSSs are susceptible to malicious attacks by electronic interference or physical intervention that degrade their reliability. Furthermore, GNSSs tend to experience location drift, which results in inaccuracies in the location information that they produce.

The Earth's geomagnetic field (GMF) is a continuous potential field that is locally unique due to its physical nature and the influence of surrounding objects (e.g. buildings, ferromagnetic materials, pillars, etc.). The GMF is stable, and changes over time are predictable and well documented. Magnetic anomalies can lead to local anomalies in the GMF. As a result, the GMF is a source of specific data that can be recorded, processed, and analyzed.

### BRIEF DESCRIPTION OF THE DRAWINGS

FIG. 1 illustrates example measurements of an example magnetic field at an example point in space.

FIG. 2 illustrates an example device including a magnetic-sensor system and GNSS receiver.

FIG. 3 illustrates an example method for detecting and correcting for location drift.

FIG. 4 illustrates another example method for detecting and correcting for location drift.

FIG. 5 illustrates an example method for determining whether a device's location or orientation has not changed.

FIG. 6 illustrates another example method for determining whether a device's location or orientation has not changed.

FIG. 7 illustrates an example computer system.

### DESCRIPTION OF EXAMPLE EMBODIMENTS

Particular embodiments use magnetic-sensor data to facilitate detection or correction of location drift in one or more GNSSs or other PNT systems. In addition or as an alternative, particular embodiments use magnetic-sensor data to facilitate determining whether a device's location or orientation has changed. In addition or as an alternative, particular embodiments use magnetic-sensor data to detect and report or correct for spoofing. Reference herein to a GNSS may include a PNT system, and vice versa, where appropriate. Location drift may include any inaccuracy in location information from a GNSS or other PNT system and may be caused by one or more technical or environmental factors such as, for example, atmospheric conditions, too few GNSS satellites being in line of site, locking on to different GNSS constellations (e.g. switching between GPS, Galileo, GLONASS, BDS, etc.), the functionality of the GNSS satellites locked on to, GNSS satellites being clustered together rather than more dispersed, interference from nearby structures (such as shadowing or reflection), being underground or indoors, radio interference or jamming, solar storms, or gaps in GNSS coverage. For example, as a result of location drift, while the location or orientation of a device containing a GNSS receiver remains unchanged, the GNSS receiver may produce location information indicating that the device's location or orientation has changed one or more times, even though it has actually remain unchanged. Although particular location drift is described and illustrated herein, this disclosure contemplates any suitable location drift. Magnetic-sensor data may be any data from one or more magnetic sensors (e.g. magnetometers), including, for example, measurements by one or more of the magnetic sensors of one or more properties of a magnetic field (e.g. the total magnetic field, the inclination angle of the magnetic field, the declination angle of the magnetic field, individual vector components of the magnetic field, etc.), the results of calculations based on those measurements, or both. Location information for a device may include the device's location (e.g. one or more points in space defined using any suitable 2D or 3D coordinate system), orientation, velocity, heading, or a combination of two or more of these. Examples of 2D or 3D coordinate systems include the Geographic Coordinate System (GCS), which identifies positions on the Earth in degrees of latitude and longitude; the Earth-Centered Earth-Fixed (ECEF) coordinate system; the Military Grid Reference System (MGRS); the Universal Transverse Mercator (UTM) grid system; or the Universal Polar Stereographic (UPS) grid system; or any other suitable coordinate system. Magnetic-sensor data may (but need not necessarily) include location information, and location information may (but need not necessarily) include magnetic-sensor data. Herein, reference to magnetic-sensor data may include location information, and vice versa, where appropriate. Herein, reference to an orientation of a device may include one or more of the device's orientation angles (e.g. heading (or yaw), elevation (or pitch), or roll (or bank)) in a joint rectangular coordinate frame relative to the Earth-Centered, Earth-Fixed (ECEF) coordinate frame or other coordinate frame, where appropriate. Moreover, reference herein to orientation may include bearing, course, direction, or heading, and vice versa, where appropriate.

In particular embodiments, one or more teachings herein may be combined in whole or in part with one or more teachings of one or more of the following, each of which is incorporated herein by reference in its entirety for all purposes: U.S. Pat. No. 11,428,532, entitled Generating a Geomagnetic Map; U.S. Pat. No. 11,680,802, entitled Correlating Overlapping Magnetic Measurement Data from Multiple Magnetic Navigation Devices and Updating a Geomagnetic Map With That Data; U.S. Pat. No. 11,725,946, entitled Operating Modes of Magnetic Navigation Devices; U.S. Pat. No. 11,719,716, entitled Measuring Distance Traversed or Speed; U.S. Patent Application Publication No. US 2023/0003544 entitled Embedding a Magnetic Map into an Image File; U.S. Patent Application No. 63/531,316, filed 8 Aug. 2023, entitled Using Magnetic-Sensor Data for Authentication and Correcting for INS Drift; U.S. Patent Application No. 63/542,292, filed 4 Oct. 2023, entitled Detecting and Correcting for Location Drift in PNT Systems; U.S. patent application Ser. No. 18/795,375, filed 6 Aug. 2024, entitled Using a Magnetic Recording for Authentication; U.S. patent application Ser. No. 18/795,387, filed 6 Aug. 2024, entitled Using Magnetic-Sensor Data to Correct for INS Drift; U.S. patent application Ser. No. 18/795,405, filed 6 Aug. 2024, entitled Determining Confidence in Magnetic-Sensor Data; U.S. patent application Ser. No. 18/795,420, filed 6 Aug. 2024, entitled Determining Movement in an Opposite Direction; or U.S. patent application Ser. No. 18/795,431, filed 6 Aug. 2024, entitled Authenticating a Device Using Geofencing Data.

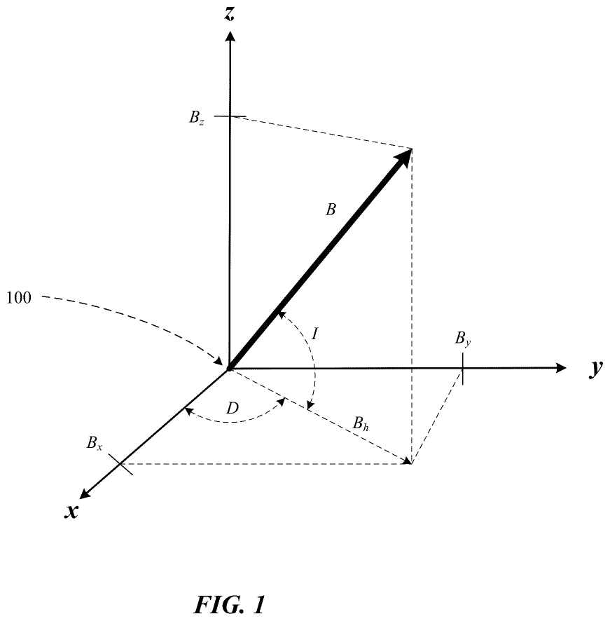

FIG. 1 illustrates example measurements of an example magnetic field at an example point 100 in space, one or more of which may be included in a magnetic recording. In the example of FIG. 1, B is a vector representing in a three-dimensional coordinate frame the magnitude (or strength) and direction of the magnetic field at point 100. The coordinate frame may be a body-fixed coordinate frame relative to a device measuring the magnetic field, such as a magnetometer or a device (such as, for example, device 200) containing the magnetometer. Bₓ is the x component of the magnitude of the magnetic field (which may be the projection of the strength of the magnetic field along the x axis of the coordinate frame), B_{y} is the y component of the magnitude of the magnetic field (which may be the projection of the strength of the magnetic field along the y axis of the coordinate frame), and B_{z} is the z component of the magnitude of the magnetic field (which may be the projection of the strength of the magnetic field along the z axis of the coordinate frame). Reference herein to a value or values of a magnetic field may include the strength of the magnetic field, the inclination angle of the magnetic field, the declination angle of the magnetic field, magnetic susceptibility, magnetic conductivity, another property of the magnetic field, or a combination of the foregoing, where appropriate. A magnetic value may a measurement or a result of a calculation. Bₕ is the magnitude of the projection of the vector of magnetic induction to a plane defined by the x and y axes of the coordinate frame, which may be a horizontal plane. D is the declination angle of the magnetic field relative to the coordinate frame, and I is the inclination angle of the magnetic field relative to the body-fixed coordinate frame. If Bₓ, B_{y}, and B_{z} are measured components of the magnetic-induction vector, e.g., by a magnetometer, then with those values the following equations may be used to determine the magnitude of the magnetic-induction vector, |B|, the magnitude of the horizontal component of B, |Bₕ|, the declination angle of the magnetic field, D, and the inclination angle of the magnetic field, I:

$$\vert B \vert = \sqrt{{B}_{x}^{2} + {B}_{y}^{2} + {B}_{z}^{2}} \qquad ( 1 )$$

$$\vert {B}_{h} \vert = \sqrt{{B}_{x}^{2} + {B}_{y}^{2}} \qquad ( 2 )$$

$$D = {cos}^{- 1} ( \frac{{B}_{x}}{{B}_{h}} ) \qquad ( 3 )$$

$$I = {sin}^{- 1} ( \frac{{B}_{z}}{B} ) \qquad ( 4 )$$

Although particular measurements of a particular magnetic field at a particular point in space is described and illustrated herein, this disclosure contemplates any suitable measurements of any suitable magnetic field at any suitable point in space. Similarly, a magnetic recording may include any suitable time or distance series of any suitable magnetic measurements, which may but need not necessarily be one or more of the magnetic measurements described and illustrated herein. Moreover, magnetic measurements may be direct magnetic measurements (e.g. Bₓ, B_{y}, or B_{z}) or calculated from direct magnetic measurements (e.g. B, Bₕ, D, I, |B|, or |Bₕ|). Herein, reference to one or more magnetic measurements may include magnetic-sensor data, and vice versa, where appropriate. Herein, reference to one or more magnetic measurements may include one or magnetic values, and vice versa, where appropriate.

In particular embodiments, a magnetometer measures the direction, strength, or relative change of a magnetic field at a point in space. In particular embodiments, a magnetometer includes one or more magneto-resistive (MR) or other sensors. In addition or as an alternative to including one or more MR sensors, a magnetometer may include one or more superconducting quantum-interference device (SQUID) sensors; search-coil sensors; nuclear-precession sensors; optically pumped sensors; fiber-optic sensors; fluxgate sensors; magneto-inductive sensors; anisotropic magneto-resistive (AMR) sensors; bias magnet field sensors; reed switches; Hall sensors; integrated Hall sensors; giant magneto-resistive (GMR) sensors; unpinned sandwich GMR sensors; antiferromagnetic-multilayer sensors; spin-valve sensors; spin-dependent tunneling (SDT) sensors; colossal magneto-resistive (CMR) sensors; or other suitable sensors for measuring a magnetic field. Although particular magnetometers including particular numbers of particular sensors are described and illustrated herein, this disclosure contemplates any suitable magnetometers including any suitable number of any suitable sensors. Moreover, although magnetometers are described and illustrated herein as taking magnetic measurements for magnetic recordings, this disclosure is not limited to magnetometers and contemplates any suitable magnetic sensors taking magnetic measurements (such as, for example, measurements of magnetic-field strength, magnetic-field inclination angle, magnetic susceptibility, magnetic conductivity, or a combination of the foregoing) for a magnetic recording.

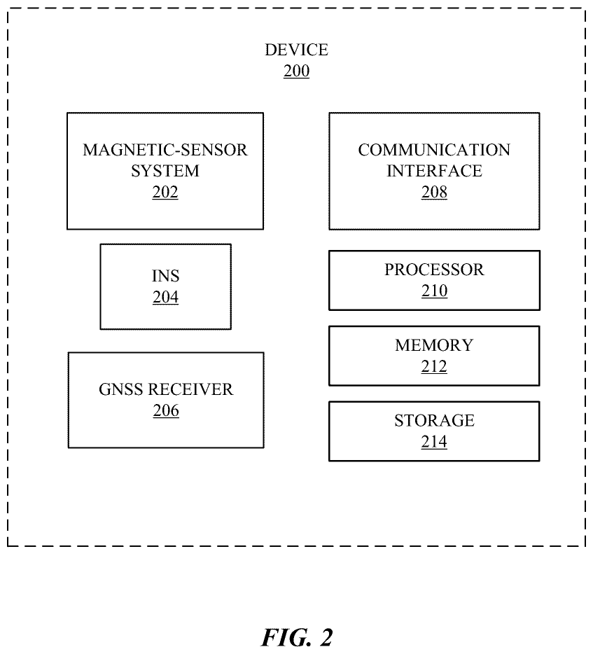

FIG. 2 illustrates an example device 200 including a magnetic-sensor system 202 and GNSS receiver 206. As an example and not by way of limitation, device 200 may, in particular embodiments, be a vehicle, robot, handheld device, or other device. Examples of vehicles include, but are not limited to, aircraft (such as, for example, airplanes, airships, and helicopters), satellites, spacecraft, ground vehicles, surface vessels or other vehicles, and underwater vehicles (such as, for example, submarines). A ground vehicle may use any suitable method(s) of terrestrial locomotion. For example, a ground vehicle may move from one location to another by rolling, sliding, walking, running, hopping, metachronal motion, slithering, brachiating, or any suitable combination of the foregoing using one or more wheels, treads, legs, or other structures. Examples of ground vehicles include, but are not limited to, conventional land vehicles, such as for example forklifts, cars, trucks, tractors, and tractor-trailer trucks. Other examples of ground vehicles include, but are not limited to, earth-moving, agricultural, or forestry equipment, such as for example excavators, backhoe loaders, bulldozers, skid-steer loaders, motor graders, crawler loaders, trenchers, scrapers, dump trucks, harvesters, mowers, balers, feller bunchers, shovel loggers, and other equipment. A surface vessel or other vehicle may be a boat or ship that operates on the surface of a body of water. One or more functions of a vehicle may be controlled by one or more human operators on board the vehicle, remotely by one or more human operators not on board the vehicle, or with a suitable degree of autonomy (such as autopilot assistance or full autonomy with no provision for human intervention or other control). A vehicle may, but need not (and need not necessarily be able to), carry one or more human passengers or crew. Although particular vehicles are described and illustrated herein, this disclosure contemplates any suitable vehicles.

Examples of robots include, but are not limited to drones, unmanned aerial vehicle (UAVs), remotely piloted aircraft (RPAs), unmanned ground vehicles (UGVs), autonomous ground vehicles (AGVs), unmanned underwater vehicles (UUVs), remotely operated underwater vehicles (ROUVs), autonomous underwater vehicles (AUVs), autonomous surface vessels or vehicles (ASVs), unmanned or uncrewed surface vessels or vehicles (USVs), drone ships, and other robots. One or more functions of a robot may be controlled by one or more human operators on board the robot, remotely by one or more human operators not on board the robot, or with a suitable degree of autonomy (such as autopilot assistance or full autonomy with no provision for human intervention or other control). A robot may, but need not (and need not necessarily be able to), carry one or more human passengers or crew. Although particular robots are described and illustrated herein, this disclosure contemplates any suitable robots. Example of handheld devices include, but are not limited to, mobile telephones, mobile computers, cameras, pagers, personal navigation devices, wearable computers, and smart cards. Although particular handheld devices are described and illustrated herein, this disclosure contemplates any suitable handheld devices with any suitable form factors. Moreover, although particular devices are described and illustrated herein, this disclosure contemplates any suitable machines, instruments, apparatuses, or other devices. For example, device 200 may include a rifle, machine gun, mortar or other artillery, or other weapon or weapon system. Device 200 may include one or more devices 200, where appropriate.

In the example of FIG. 2, device 200 includes magnetic-sensor system 202, INS 204, GNSS receiver 206, communication interface 208, processor 210, memory, 212, and storage 214. Device 200 may also include one or more other components or systems not illustrated in the example of FIG. 2. For example, if device 200 is a vehicle, device 200 may also include one or more engines, motors, or propulsion systems. As another example, if device 200 is a mobile telephone, then device 200 may also include one or more batteries, one or more microphones, one or more speakers, and one or more touchscreens with associated controllers. Magnetic-sensor system 202 may include one or more magnetic sensors (such as, for example, magnetometers) and other hardware, software, or both for controlling and collecting measurements from the magnetic sensors. Herein reference to a magnetic sensor may include a magnetometer, and vice versa, where appropriate. As described above, a magnetometer is a device that measures an external magnetic field or magnetic dipole moment. In particular embodiments, a magnetometer measures the direction, strength, or relative change of a magnetic field at a point in space. Although a particular magnetic-sensor system 202 is described and illustrated herein, this disclosure contemplates any suitable magnetic-sensor system. Magnetic-sensor system 202 may include one or more magnetic-sensor systems 202, where appropriate.

INS 204 may include one or more motion sensors (e.g. accelerometers), one or more rotation sensors (e.g. gyroscopes), and other hardware, software, or both for controlling and collecting measurements from those sensors and may calculate by dead reckoning the position, orientation, or velocity (e.g. including direction and speed of movement) of device 200 using those measurements. INS 204 may also include one or more magnetic sensors (such as, for example, magnetometers), which may serve as a compass or other instrument. INS 204 may also include one or more pressure sensors, which may serve as an altimeter, barometer, or bathymeter (or bathometer). INS 204 may include one or more inertial measurement units (IMUs). An IMU may include one or more motion sensors (e.g. accelerometers), one or more rotation sensors (e.g. gyroscopes), and other hardware, software, or both for controlling and collecting measurements from those sensors and may calculate a specific force, angular rate, and orientation of an object (e.g. device 200) using those measurements. In addition or as an alternative, the IMU may calculate an absolute spatial displacement of the object using those measurements. The IMU may also include one or more pressure sensors, which may serve as an altimeter, barometer, or bathymeter (or bathometer). Herein, reference to an INS may include an IMU, an inertial guidance system, or an inertial instrument, and vice versa, where appropriate. Although a particular INS is described and illustrated herein, this disclosure contemplates any suitable INS. Although a particular IMU is described and illustrated herein, this disclosure contemplates any suitable IMU. INS 204 may include one or more INSs 204, where appropriate.

GNSS receiver 206 may include hardware, software, or both for receiving signals from GNSS satellites and calculating a position of GNSS receiver 206 (or, by extension, device 200 including GNSS receiver 206) from those signals. GNSS is a general term used to describe a network of satellites that can be used to produce PNT data sets. GPS is a widely used form of GNSS. Regional applications of such systems are also used to generate more regionally specific PNT data. For example, Galileo can be used in Europe; GLONASS can be used in Russia; and BDS can be used in China. GNSSs can have failure points. For example, some GNSSs lose reliability when operated inside buildings or in areas where network communication to the device is intermittent. Some GNSSs lose reliability when operated in dense city environments where large buildings interfere with communication signals. Some GNSSs lose reliability when operated in areas such as caves, tunnels, and mountains that impede reception of signals from GNSS satellites. Moreover, some GNSSs are susceptible to malicious attacks by electronic interference or physical intervention that degrade their reliability. Although a particular GNSS receiver 206 is disclosed and illustrated, this disclosure contemplates any suitable GNSS receiver. GNSS receiver 206 may include one or more GNSS receivers 206, where appropriate.

Communication interface 208 may include hardware, software, or both providing one or more interfaces for wired communication, wireless communication, or optical communication (such as, for example, fiber-optic communication), or a combination of the foregoing, between device 200 and one or more other devices or computer systems or one or more networks. As an example and not by way of limitation, communication interface 208 may provide one or more interfaces for radio communication. In addition or as an alternative, communication interface 208 may provide one or more interfaces for communication with one or more wireless networks, such as, for example, one or more wireless ad hoc networks; one or more Bluetooth networks or other wireless personal area networks (WPANs); one or more Wi-Fi networks or other wireless local area networks (WLANs); one or more wide area networks (WANs); one or more Worldwide Interoperability for Microwave Access (WiMAX) networks or other wireless metropolitan area networks (WMANs); or one or more other suitable wireless networks. In addition or as an alternative, communication interface 208 may provide one or more interfaces for communication with one or more cellular networks, such as for example, one or more Global System for Mobile Communications (GSM) networks; one or more Code-Division Multiple Access (CDMA) networks; one or more General Packet Radio Service (GPRS) networks; one or more Wideband Code-Division Multiple Access (WCDMA) networks; one or more Enhanced Data rates for GSM Evolution (EDGE) networks; one or more CDMA2000 networks; one or more 3rd Generation Partnership Project (3GPP) 5G networks; or one or more other suitable cellular networks. In addition or as an alternative, communication interface 208 may provide one or more interfaces for communication with one or more low-power wide-area network (LPWANs). In addition or as an alternative, communication interface 208 may provide one or more interfaces for communication with one or more mobile-satellite services (MSSs). In addition or as an alternative, communication interface 208 may provide one or more interfaces for communication with one or more wireless sensor networks (WSNs). In addition or as an alternative, communication interface 208 may provide one or more interfaces for near-field communication (NFC). Although a particular communication interface 208 is disclosed and illustrated, this disclosure contemplates any suitable communication interface. Communication interface 208 may include one or more communication interfaces 208, where appropriate.

Processor 210 may include hardware for executing instructions, such as those making up a computer program or other software. As an example and not by way of limitation, to execute instructions, processor 210 may retrieve (or fetch) the instructions from an internal register, an internal cache, memory 212, or storage 214; decode and execute them; and then write one or more results to an internal register, an internal cache, memory 212, or storage 214. Although this disclosure describes and illustrates a particular processor 210, this disclosure contemplates any suitable processor. Processor 210 may include one or more processors 210, where appropriate.

Memory 212 may include main memory for storing instructions for processor 210 to execute or data for processor 210 to operate on. As an example and not by way of limitation, instructions may be loaded from storage 214 or another source to memory 212. Processor 210 may then load the instructions from memory 212 to an internal register or internal cache. To execute the instructions, processor 210 may retrieve the instructions from the internal register or internal cache and decode them. During or after execution of the instructions, processor 210 may write one or more results (which may be intermediate or final results) to the internal register or internal cache. Processor 210 may then write one or more of those results to memory 212. Although this disclosure describes and illustrates particular memory 212, this disclosure contemplates any suitable memory. Memory 212 may include one or more memories 212, where appropriate.

Storage 214 may include mass storage for data or instructions. As an example and not by way of limitation, storage 214 may include a hard disk drive (HDD), a floppy disk drive, flash memory, an optical disc, a magneto-optical disc, magnetic tape, or a Universal Serial Bus (USB) drive or a combination of two or more of these. Storage 214 may include removable or non-removable (or fixed) media, where appropriate. Storage 214 may be internal or external to device 200, where appropriate. Storage 214 may be non-volatile, solid-state memory. Storage 214 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 214 taking any suitable physical form. Storage 214 may include one or more storage control units facilitating communication between processor 210 and storage 214, where appropriate. Where appropriate, storage 214 may include one or more storages 214. Although this disclosure describes and illustrates particular storage 214, this disclosure contemplates any suitable storage.

Although a particular device 200 having a particular arrangement of particular numbers of particular components and systems is described and illustrated herein, this disclosure contemplates any suitable device having any suitable arrangement of any suitable numbers of any suitable components or systems. As an example and not by way of limitation, a device contemplated by this disclosure may include magnetic-sensor system 202, processor 210, memory 212, and storage 214 and not include INS 204, GNSS receiver 206, and communication interface 208. A device contemplated by this disclosure may include some, all, or none of magnetic-sensor system 202, INS 204, GNSS receiver 206, communication interface 208, processor 210, memory 212, and storage 214. In addition, as described above, a device contemplated by this disclosure may include one or more components or systems not illustrated in FIG. 2 or described with respect thereto or otherwise described or illustrated herein. A device contemplated by this disclosure may include one or more fusion filters (which may be a set of instructions functioning as fusion filters when executed) stored in memory 212 or storage 214 and executable by processor 210, magnetic-sensor system 202, INS 204, or any other suitable component or system of device 200. In particular embodiments, a fusion filter is an algorithm that may be used in sensor fusion to combine data from multiple sensors, resulting in a more accurate estimate of a system being measured. A fusion filter may reduce errors and uncertainty and thereby improve the accuracy and reliability of the system. A fusion filter may combine data from multiple sensors measuring the same variable(s), such as position or orientation, and then apply statistical techniques to that data to estimate the most likely value of the variable(s). An advantage of fusion filters is their ability to deal with noisy or unreliable sensor data. By combining data from multiple sources, a fusion filter may reduce the impact of any individual sensor's errors or biases, resulting in a more accurate estimate of the system being measured.

The fusion filter(s) may receive or otherwise access data from one or more of magnetic-sensor system 202, INS 204, one or more other sensors or sensor systems of device 200, GNSS receiver 206, communication interface 208, or one or more other components, systems, or sub-systems of device 200 and combine that data to produce location information for device 200 (including, for example, position, orientation, or velocity (e.g. including direction and speed of movement) of device 200) that is more certain and contains fewer errors than the original data. In particular embodiments, the fusion filter(s) may detect or correct location drift by GNSS receiver 206 or other PNT systems of device 200. In addition or as an alternative, the fusion filter(s) may use magnetic-sensor data to determine whether the location or orientation of device 200 changed or has changed. In addition or as an alternative, the fusion filter(s) may use magnetic-sensor data to determine whether GNSS spoofing is occurring or has occurred. Reference to data may include a data set, and vice versa, where appropriate. The fusion filter(s) may be a component or sub-system of magnetic-sensor system 202, INS 204, or another component, system, or sub-system of device 200. Although a particular fusion filter is described and illustrated herein, this disclosure contemplates any suitable fusion filter.

Two or more of magnetic-sensor system 202, INS 204, GNSS receiver 206, communication interface 208, processor 210, memory 212, storage 214, or any other component or system of device 200 may be connected to each other directly or functionally, physically, or logically co-located with each other in whole or in part. For example, magnetic-sensor system 202 (or one or more components or functions of magnetic-sensor system 202) may be a component of INS 204. In addition or as an alternative, INS 204 may include its own dedicated processor 210, memory 212, or storage 214. In addition or as an alternative, magnetic-sensor system 202 and INS 204 may be subsystems of a system or component of device 200, which may include its own dedicated processor 210, memory 212, or storage 214. One or more functions described or illustrated herein as being provided by one or more particular components or systems of device 200 may be provided by one or more other suitable components or systems of device 200 and need not necessarily be provided by the particular components or systems of device 200 described or illustrated herein as providing those functions.

As described above, GNSS receiver 206 will tend to experience location drift, which will result in inaccuracies in the location information that it produces. Other PNT systems may also experience location drift. In contrast, in particular embodiments, magnetic-sensor system 202 will tend to experience little or no location drift. Particular embodiments may use this to detect or correct location drift by GNSS receiver 206 or other PNT systems of device 200. For example, if the location or orientation of device 200 does not change, there should be little or no variance in one or more value(s) of the external magnetic field measured or calculated by magnetic-sensor system 202. In particular embodiments, if location information from GNSS receiver 206 indicates that the location or orientation of device 200 has changed one or more times while, at the same time, variance in one or more value(s) of the external magnetic field measured or calculated by magnetic-sensor system 202 has stayed within a predetermined range (which may be relative to the amount of location or orientation change indicated by GNSS receiver 206), then it may be determined that location drift is present in the location information from GNSS receiver 206 and that the location or orientation of device 200 has actually remain unchanged during that time. This determination may be made in approximate real time or in post-processing, potentially with different parameters for calculations performed at different times. In particular embodiments, based on that determination, the location information may be adjusted to correct for that location drift, for example, by calculating a spatial midpoint or average location between or among the locations indicated by the location information and setting that as the location of device 200 during that time. As an alternative, the initial location of device 200 when the location drift first appeared may be set as the location of device 200 during that time. Although particular corrections for particular location information affected by particular location drift are described and illustrated herein, this disclosure contemplates any suitable corrections for any suitable location information affected by any suitable location drift. Such correction may be performed in approximate real time or in post-processing, potentially with different parameters for calculations performed at different times.

In particular embodiments, variance in one or more value(s) of the external magnetic field measured or calculated by magnetic-sensor system 202 (such as, for example, total magnetic field or one or more other properties of the external magnetic field in addition or as alternative to the total magnetic field) may be calculated over a sliding or other window of a predetermined length k (e.g. 200-300 samples at a sampling rate of 50 Hz) or another window, which may correspond to the location information from GNSS receiver 206 being analyzed (in approximate real time or in post-processing). In particular embodiments, the variance may be calculated as the squared deviation from the mean of the value of the total magnetic field (or one or more other properties of the magnetic field in addition or as alternative to the total magnetic field) over the window. In particular embodiments, the variance may be calculated as the square of the standard deviation of the value of the total magnetic field (or one or more other properties of the magnetic field in addition or as alternative to the total magnetic field) over the window. In particular embodiments, the variance may be a measure of dispersion within the window, indicating how far the values in the window spread out from their mean or median value. In particular embodiments, the variance may be calculated using one or more difference (or distance) calculations or one or more similarity calculations (e.g. between or among magnetic recordings) disclosed in U.S. Patent Application No. 63/542,292, which this application claims the benefit of under 35 U.S.C. § 119 (e) and which is incorporated herein by reference in its entirety for all purposes. In particular embodiments, the variance may be calculated using a nearest centroid classifier. In particular embodiments, the variance may be calculated using correlation optimized warping (COW) or dynamic time warping (DTW). In particular embodiments, the variance may be calculated using one or more similarity correlation analyses (which may but need not necessarily include the use of normalized correlation coefficients (NCCs)) disclosed in U.S. Pat. No. 11,428,532, entitled Generating a Geomagnetic Map, U.S. Pat. No. 11,680,802, entitled Correlating Overlapping Magnetic Measurement Data from Multiple Magnetic Navigation Devices and Updating a Geomagnetic Map With That Data, U.S. Pat. No. 11,725,946, entitled Operating Modes of Magnetic Navigation Devices, each of which is incorporated herein by reference in its entirety for all purposes. Although particular calculations of particular variances of a magnetic field are described and illustrated herein, this disclosure contemplates any suitable calculation(s) or combination of calculations based on any suitable measurements of a magnetic field.

In particular embodiments, disturbances in the external magnetic field may be filtered out of the calculation of variance in one or more value(s) of the external magnetic field measured or calculated by magnetic-sensor system 202. A disturbance in the external magnetic field may be caused, for example, by a geomagnetic storm, an object being momentarily in proximity with device 200 (e.g. a vehicle and device 200 passing by each other), or other event. Particular embodiments may filter out a disturbance in the external magnetic field based on one or more specific characteristics of the disturbance. For example, when a disturbance in the external magnetic field occurs, there may be a sudden (or even instantaneous) change in the value of the total magnetic field measured or calculated by magnetic-sensor system 202 and that change may occur in all directions at once and then suddenly (or even instantaneously) disappear. Although particular specific characteristics of particular disturbances in particular external magnetic fields are described and illustrated herein, this disclosure contemplates any suitable specific characteristics of any suitable disturbance in any suitable external magnetic field. When a disturbance in the external magnetic field occurs, magnetic-sensor system 202 or another component or subsystem of device 200 (such as a fusion filter) may detect the disturbance based on the specific characteristics of the disturbance (e.g. duration, amount, and direction) and then filter out the disturbance based on those characteristics. This may be done by subtracting or otherwise removing the changes attributable to the disturbance (which may be determined based on the specific characteristics of the disturbance) from one or more value(s) of the external magnetic field measured or calculated by magnetic-sensor system 202. Variance in the external magnetic field may then be calculated with the adjusted value(s). In addition or as an alternative, this may be done by excluding the value(s) affected by the disturbance from any variance calculations. Although particular filtering of particular disturbances in particular external magnetic fields from particular calculations or measurements is described and illustrated herein, this disclosure contemplates any suitable filtering of any suitable disturbance in any suitable external magnetic field from any suitable calculation or measurement.

In addition or as an alternative to using the above techniques for detecting or correcting for location drift, particular embodiments may compare location information from GNSS receiver 206 with location information from magnetic-sensor system 202 and detect or correct for location drift in the location information from GNSS receiver 206 based on that comparison. For example, GNSS receiver 206 may determine location information for device 200, for example, at a polling rate of 1 Hz, 5 Hz, 10 Hz, or 20 Hz. (Although a particular GNSS receiver determining location information at particular polling rates is described and illustrated, this disclosure contemplates any suitable GNSS receiver determining location information at any suitable polling rates.) At the same time, magnetic-sensor system 202 may also determine location information for device 200, for example, at a sampling rate of 50 Hz. For example, magnetic-sensor system 202 may determine location information for device 200 using one or more apparatuses, systems, or methods disclosed in U.S. Pat. No. 11,428,532, entitled Generating a Geomagnetic Map, U.S. Pat. No. 11,680,802, entitled Correlating Overlapping Magnetic Measurement Data from Multiple Magnetic Navigation Devices and Updating a Geomagnetic Map With That Data, U.S. Pat. No. 11,725,946, entitled Operating Modes of Magnetic Navigation Devices, U.S. Pat. No. 11,719,716, entitled Measuring Distance Traversed or Speed, or U.S. Patent Application Publication No. US 2023/0003544 entitled Embedding a Magnetic Map into an Image File, each of which is incorporated herein by reference in its entirety for all purposes. In particular embodiments, the polling rate of GNSS receiver 206 and sampling rate of magnetic-sensor system 202 may be aligned or synchronized with each other in whole or in part. The location information from GNSS receiver 206 may be compared with the location information from magnetic-sensor system 202 in approximate real time or in post-processing. If the location information from magnetic-sensor system 202 indicates that the location or orientation of device 200 has not changed during that time and the location information from GNSS receiver 206 indicates that the location of device 200 has changed one or more times during that time, then it may be determined that location drift is present in the location information from GNSS receiver 206 and that the location or orientation of device 200 has actually remain unchanged during that time. In addition or as an alternative, particular embodiments may quantify one or more differences between the location information from magnetic-sensor system 202 and the location information from GNSS receiver 206 and determine whether one or more of those differences exceed a predetermined range. In particular embodiments, based on that determination, the location information from GNSS receiver 206 may be adjusted to correct for the determined location drift, for example, by calculating a spatial midpoint or average location between or among the locations indicated by the location information and setting that as the location of device 200 during that time. As an alternative, the initial location of device 200 when the location drift first appeared may be set as the location of device 200 during that time. As another alternative, the location information from magnetic-sensor system 202 may be used to set the location of device 200 during that time. Although particular corrections for particular location information affected by particular location drift are described and illustrated herein, this disclosure contemplates any suitable corrections for any suitable location information affected by any suitable location drift.

Particular embodiments may use one or more of the above techniques to determine whether the location or orientation of device 200 changed or is changing, with or without location information from GNSS receiver 206 or another PNT system. For example, as described above, while the location or orientation of device 200 does not change, there should be little or no variance in one or more value(s) of the external magnetic field measured or calculated by magnetic-sensor system 202. In particular embodiments, if variance in one or more value(s) of the external magnetic field measured or calculated by magnetic-sensor system 202 (such as, for example, total magnetic field or one or more other properties of the external magnetic field in addition or as alternative to the total magnetic field) stays within a predetermined range during a period of time, then it may be determined that the location or orientation of device 200 did not change during that period of time, which may be determined in approximate real time or in post-processing. Variance in one or more value(s) of the external magnetic field measured or calculated by magnetic-sensor system 202 may be calculated as described above. In addition or as an alternative to the above technique, particular embodiments may compare location information from magnetic-sensor system 202 at different times and based on that comparison determine whether the location or orientation of device 200 changed at those times. Magnetic-sensor system 202 may determine the location of device 200 as described above.

Particular embodiments may use one or more of the above techniques to detect and report or correct for spoofing. Spoofing may include the broadcasting of false GNSS or other signals to cause GNSS or other receivers or interfaces in the affected area to produce inaccurate location information based on those false signals. This may occur with the determination of location information by GNSS receiver 206, communication interface 208, or one or more other components or subsystems of device 200. In particular embodiments, magnetic-sensor system 202 will be much less susceptible to spoofing. Particular embodiments may use this to detect and report or correct for spoofing affecting GNSS receiver 206 or other components or subsystems of device 200. For example, if location information from GNSS receiver 206 contradicts or otherwise does not coincide with location information from magnetic-sensor system 202 (especially if the difference between the two occurs gradually over time), then it may be determined that GNSS receiver 206 is experiencing spoofing. This determination may be made in approximate real time or in post-processing, potentially with different parameters for calculations performed at different times. If location information from GNSS receiver 206 indicates that the location, heading, or velocity of device 200 is changing or has changed when location information from magnetic-sensor system 202 indicates that the location, heading, or velocity of device 200 is not changing or has not changed, then it may be determined that location information from GNSS receiver 206 contradicts location information from magnetic-sensor system 202. In addition or as an alternative, if the location, heading, or velocity of device 200 indicated by location information from GNSS receiver 206 at one or more times differs from the location, heading, or velocity of device 200 indicated by location information from magnetic-sensor system 202 at those times, then it may be determined that location information from GNSS receiver 206 contradicts location information from magnetic-sensor system 202. In particular embodiments, this may indicate that GNSS receiver 206 is being spoofed. As described above, location information from magnetic-sensor system 202 may be generated or determined (e.g. calculated) using one or more apparatuses, systems, or methods disclosed in U.S. Pat. No. 11,428,532, entitled Generating a Geomagnetic Map, U.S. Pat. No. 11,680,802, entitled Correlating Overlapping Magnetic Measurement Data from Multiple Magnetic Navigation Devices and Updating a Geomagnetic Map With That Data, U.S. Pat. No. 11,725,946, entitled Operating Modes of Magnetic Navigation Devices, or U.S. Pat. No. 11,719,716, entitled Measuring Distance Traversed or Speed, U.S. Patent Application Publication No. US 2023/0003544 entitled Embedding a Magnetic Map into an Image File; U.S. Patent Application No. 63/531,316, filed 8 Aug. 2023, entitled Using Magnetic-Sensor Data for Authentication and Correcting for INS Drift; U.S. Patent Application No. 63/542,292, filed 4 October 2023, entitled Detecting and Correcting for Location Drift in PNT Systems; U.S. patent application Ser. No. 18/795,375, filed 6 Aug. 2024, entitled Using a Magnetic Recording for Authentication; U.S. patent application Ser. No. 18/795,387, filed 6 Aug. 2024, entitled Using Magnetic-Sensor Data to Correct for INS Drift; U.S. patent application Ser. No. 18/795,405, filed 6 Aug. 2024, entitled Determining Confidence in Magnetic-Sensor Data; U.S. patent application Ser. No. 18/795,420, filed 6 Aug. 2024, entitled Determining Movement in an Opposite Direction; or U.S. patent application Ser. No. 18/795,431, filed 6 Aug. 2024, entitled Authenticating a Device Using Geofencing Data, each of which is incorporated herein by reference in its entirety for all purposes. Herein, reference to generating location information may include determining location information, and vice versa, where appropriate. When it is determined that GNSS receiver 206 is experiencing or has experienced spoofing, particular embodiments may generate a notification or otherwise report the spoofing to a user of device 200 or to one or more other users or other devices. In addition or as an alternative, particular embodiments may adjust location information from GNSS receiver 206 by one or more other components or subsystems of device (such as on one or more fusion filters). In addition or as an alternative, particular embodiments may correct for the spoofing using one or more of the techniques described above for correcting location information.

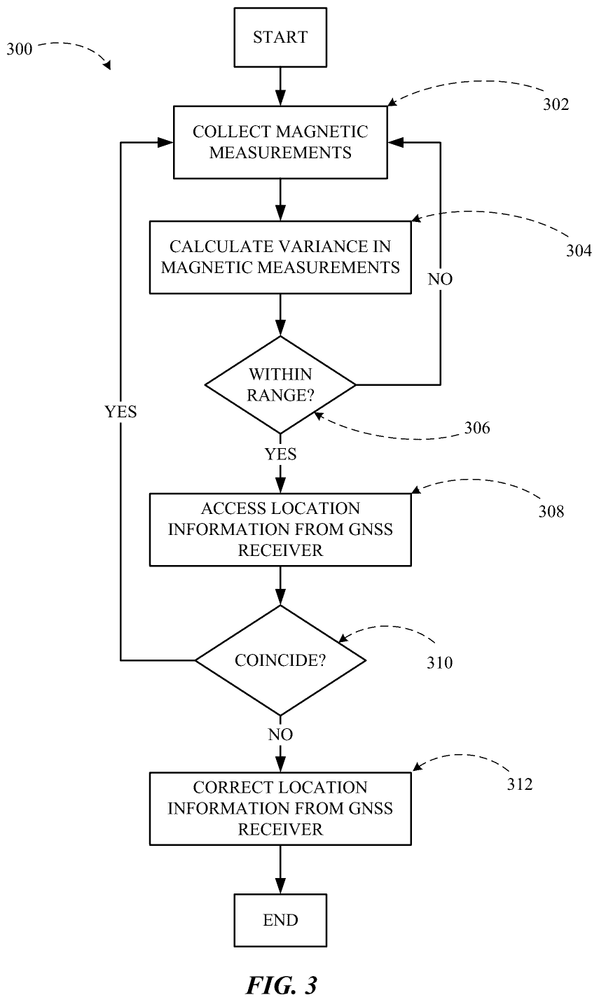

FIG. 3 illustrates an example method 300 for detecting and correcting location drift. Method 300 begins at step 302, where magnetic-sensor system 202 collects magnetic measurements. The magnetic measurements may be measured or calculated values of the external magnetic field, such as, for example, the strength of the magnetic field, the inclination angle of the magnetic field, magnetic susceptibility, magnetic conductivity, another property of the magnetic field, or a combination of the foregoing, where appropriate. At step 304, a variance in the magnetic measurements is calculated over a sliding or other window of predetermined length k (e.g. 200-300 samples at a sampling rate of 50 Hz) or another window. As described above, the variance may be calculated as the squared deviation from the mean of the value of the total magnetic field (or one or more other properties of the magnetic field in addition or as alternative to the total magnetic field) over the window. The variance may be calculated as the square of the standard deviation of the value of the total magnetic field (or one or more other properties of the magnetic field in addition or as alternative to the total magnetic field) over the window. The variance may be a measure of dispersion within the window, indicating how far the values in the window spread out from their mean or median value. The variance may be calculated using a difference (or distance) calculation disclosed in U.S. Patent Application No. 63/542,292, which this application claims the benefit of under 35 U.S.C. § 119 (e) and which is incorporated herein by reference in its entirety for all purposes. In addition or as an alternative, the variance may be calculated using a nearest centroid classifier, COW, or DTW, or another suitable technique. In addition or as an alternative, the variance may be calculated using one or more similarity correlation analyses (which may but need not necessarily include the use of NCCs). As described above, disturbances (if any) in the external magnetic field may be filtered out of the calculation of variance in one or more value(s) of the external magnetic field measured or calculated by magnetic-sensor system 202. This may occur as part of the variance calculation at step 304.

At step 306, if the variance is outside a predetermined range (e.g. indicating that the location or orientation of device 200 changed in the window), then method 300 returns to step 302. At step 306, if the variance is within the predetermined range (e.g. indicating that the location or orientation of device 200 did not change in the window), then method 300 proceeds to step 308. At step 308, location information from GNSS receiver 206 in the window is accessed. At step 310, if the location information from GNSS receiver 206 coincides with the indication at step 306 that the location or orientation of device 200 did not change in the window, then method 300 returns to step 302. At step 310, if the location information from GNSS receiver 206 does not coincide with the indication at step 306 that the location or orientation of device 200 did not change in the window, then method 300 proceeds to step 312. In particular embodiments, if at step 310 the location information from GNSS receiver 206 does not coincide with the location information from magnetic-sensor system 202, then it may be determined, for example, that GNSS receiver 206 is or was being spoofed. When it is determined that GNSS receiver 206 is experiencing or has experienced spoofing, particular embodiments may generate a notification or otherwise report the spoofing to a user of device 200 or to one or more other users or other devices. At step 312, the location information from GNSS receiver 206 is corrected to indicate that the location or orientation of device 200 did not change in the window, at which point method 300 ends. As described above, the location information may be corrected by calculating a spatial midpoint or average location between or among the locations indicated by the location information and setting that as the location of device 200 throughout the window. As an alternative, the location information may be corrected by setting the initial location of device 200 in the window as the location of device 200 throughout the window.

Particular embodiments may repeat one or more steps of method 300, where appropriate. Although this disclosure describes and illustrates particular steps of method 300 as occurring in a particular order, this disclosure contemplates any suitable steps of method 300 occurring in any suitable order. Moreover, although this disclosure describes and illustrates an example method for detecting and correcting location drift including the particular steps of method 300, this disclosure contemplates any suitable method for detecting and correcting location drift including any suitable steps, which may include all, some, or none of the steps of method 300, where appropriate. Furthermore, although this disclosure describes and illustrates particular components, devices, or systems carrying out particular steps of method 300, this disclosure contemplates any suitable combination of any suitable components, devices, or systems carrying out any suitable steps of method 300.

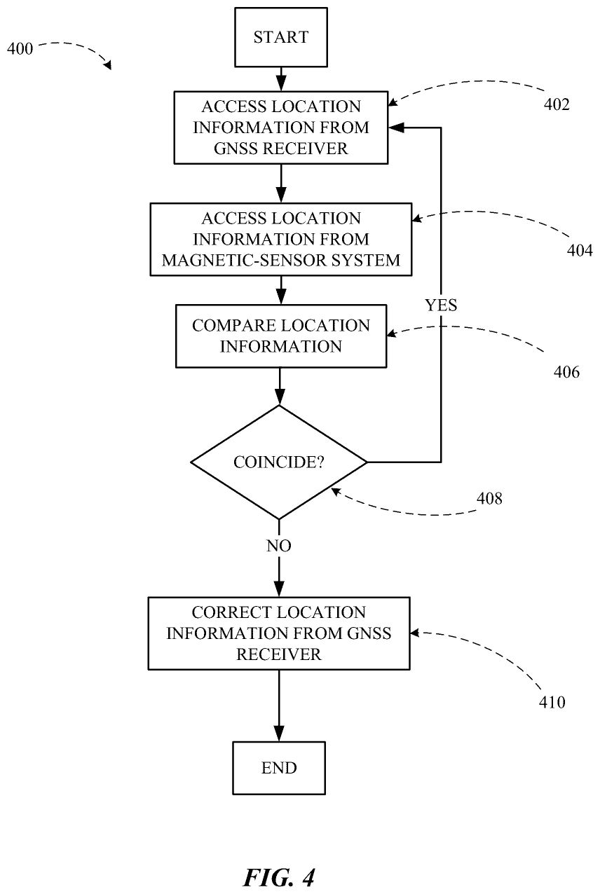

FIG. 4 illustrates another example method 400 for detecting and correcting for location drift in location information. Method 400 begins at step 402, where location information from GNSS receiver 206 is accessed. At step 404, location information from magnetic-sensor system 202 concurrent with the location information from GNSS receiver 206 is accessed. As described above, magnetic-sensor system 202 may determine location information for device 200 using one or more apparatuses, systems, or methods disclosed in U.S. Pat. No. 11,428,532, entitled Generating a Geomagnetic Map, U.S. Pat. No. 11,680,802, entitled Correlating Overlapping Magnetic Measurement Data from Multiple Magnetic Navigation Devices and Updating a Geomagnetic Map With That Data, U.S. Pat. No. 11,725,946, entitled Operating Modes of Magnetic Navigation Devices, U.S. Pat. No. 11,719,716, entitled Measuring Distance Traversed or Speed, or U.S. Patent Application Publication No. US 2023/0003544 entitled Embedding a Magnetic Map into an Image File, each of which is incorporated herein by reference in its entirety for all purposes. At step 406, the location information from GNSS receiver 206 is compared with the location information from magnetic-sensor system 202. At step 408, if the location information from GNSS receiver 206 and the location information from magnetic-sensor system 202 coincide with respect to change in the location or orientation of device 200, then method 400 returns to step 402. At step 408, if the location information from GNSS receiver 206 does not coincide with the location information from magnetic-sensor system 202 with respect to change in the location or orientation of device 200 and the location information from magnetic-sensor system 202 indicates that the location or orientation of device 200 did not change, then method 400 proceeds to step 410. In particular embodiments, if at step 408 the location information from GNSS receiver 206 does not coincide with the location information from magnetic-sensor system 202, then it may be determined, for example, that GNSS receiver 206 is or was being spoofed. When it is determined that GNSS receiver 206 is experiencing or has experienced spoofing, particular embodiments may generate a notification or otherwise report the spoofing to a user of device 200 or to one or more other users or other devices. At step 410, the location information from GNSS receiver 206 is corrected to indicate that the location or orientation of device 200 did not change, at which point method 400 ends. As described above, the location information may be corrected by calculating a spatial midpoint or average location between or among the locations indicated by the location information and setting that as the location of device 200 during that time period. As an alternative, the location information may be corrected by setting the initial location of device 200 during that time period as the location of device 200 throughout that time period. As another alternative, the location information from magnetic-sensor system 202 may be used to set the location of device 200 during that time period.

Particular embodiments may repeat one or more steps of method 400, where appropriate. Although this disclosure describes and illustrates particular steps of method 400 as occurring in a particular order, this disclosure contemplates any suitable steps of method 400 occurring in any suitable order. Moreover, although this disclosure describes and illustrates an example method for detecting and correcting location drift including the particular steps of method 400, this disclosure contemplates any suitable method for detecting and correcting location drift including any suitable steps, which may include all, some, or none of the steps of method 400, where appropriate. Furthermore, although this disclosure describes and illustrates particular components, devices, or systems carrying out particular steps of method 400, this disclosure contemplates any suitable combination of any suitable components, devices, or systems carrying out any suitable steps of method 400.

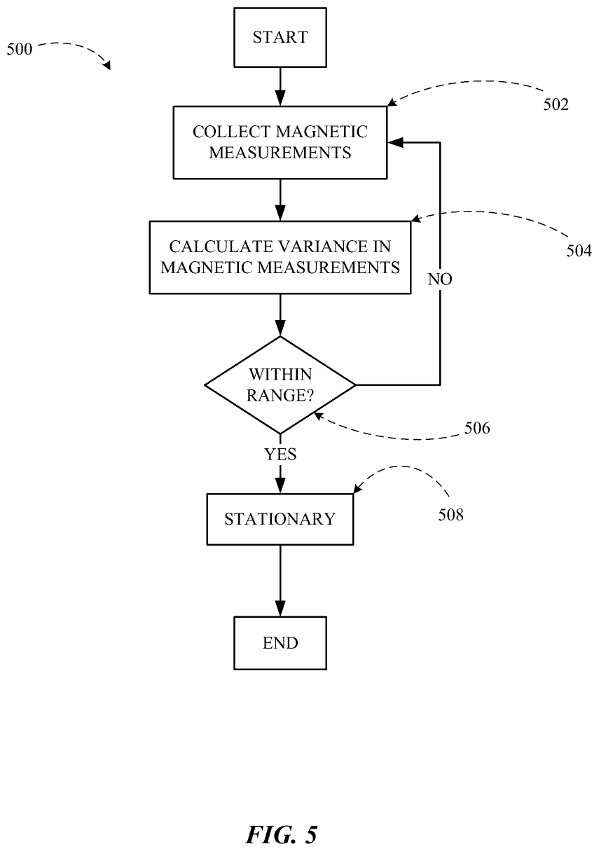

FIG. 5 illustrates an example method 500 for determining whether a device's location or orientation has not changed. Method 500 begins at step 502, where magnetic-sensor system 202 collects magnetic measurements. The magnetic measurements may be measured or calculated values of the external magnetic field, such as, for example, the strength of the magnetic field, the inclination angle of the magnetic field, magnetic susceptibility, magnetic conductivity, another property of the magnetic field, or a combination of the foregoing, where appropriate. At step 504, a variance in the magnetic measurements is calculated over a sliding or other window of predetermined length k (e.g. 200-300 samples at a sampling rate of 50 Hz) or another window. As described above, the variance may be calculated as the squared deviation from the mean of the value of the total magnetic field (or one or more other properties of the magnetic field in addition or as alternative to the total magnetic field) over the window. The variance may be calculated as the square of the standard deviation of the value of the total magnetic field (or one or more other properties of the magnetic field in addition or as alternative to the total magnetic field) over the window. The variance may be a measure of dispersion within the window, indicating how far the values in the window spread out from their mean or median value. The variance may be calculated using a difference (or distance) calculation disclosed in U.S. Patent Application No. 63/542,292, which this application claims the benefit of under 35 U.S.C. § 119 (e) and which is incorporated herein by reference in its entirety for all purposes. In addition or as an alternative, the variance may be calculated using a nearest centroid classifier, COW, or DTW, or another suitable technique. In addition or as an alternative, the variance may be calculated using one or more similarity correlation analyses (which may but need not necessarily include the use of NCCs). As described above, disturbances (if any) in the external magnetic field may be filtered out of the calculation of variance in one or more value(s) of the external magnetic field measured or calculated by magnetic-sensor system 202. This may occur as part of the variance calculation at step 504. At step 506, if the variance is outside a predetermined range (e.g. indicating that the location or orientation of device 200 changed in the window), then method 500 returns to step 502. At step 506, if the variance is within the predetermined range (e.g. indicating that the location or orientation of device 200 did not change in the window), then method 500 proceeds to step 508. At step 508, it is determined that device 200 was stationary (e.g. the location or orientation of device 200 did not change) in the window, at which point method 300 ends. In particular embodiments, this determination may be compared with location information from GNSS receiver 206, for example, to determine whether GNSS receiver 206 is being spoofed. If it is determined at step 508 that device 200 was stationary, but information from GNSS receiver 206 indicates that the location or orientation of device 200 changed during that time, then it may be determined that GNSS receiver 206 was being spoofed during that time. When it is determined that GNSS receiver 206 is experiencing or has experienced spoofing, particular embodiments may generate a notification or otherwise report the spoofing to a user of device 200 or to one or more other users or other devices.

Particular embodiments may repeat one or more steps of method 500, where appropriate. Although this disclosure describes and illustrates particular steps of method 500 as occurring in a particular order, this disclosure contemplates any suitable steps of method 500 occurring in any suitable order. Moreover, although this disclosure describes and illustrates an example method for determining whether a device's location or orientation has changed including the particular steps of method 500, this disclosure contemplates any suitable method for determining whether a device's location or orientation has changed including any suitable steps, which may include all, some, or none of the steps of method 500, where appropriate. Furthermore, although this disclosure describes and illustrates particular components, devices, or systems carrying out particular steps of method 500, this disclosure contemplates any suitable combination of any suitable components, devices, or systems carrying out any suitable steps of method 500.

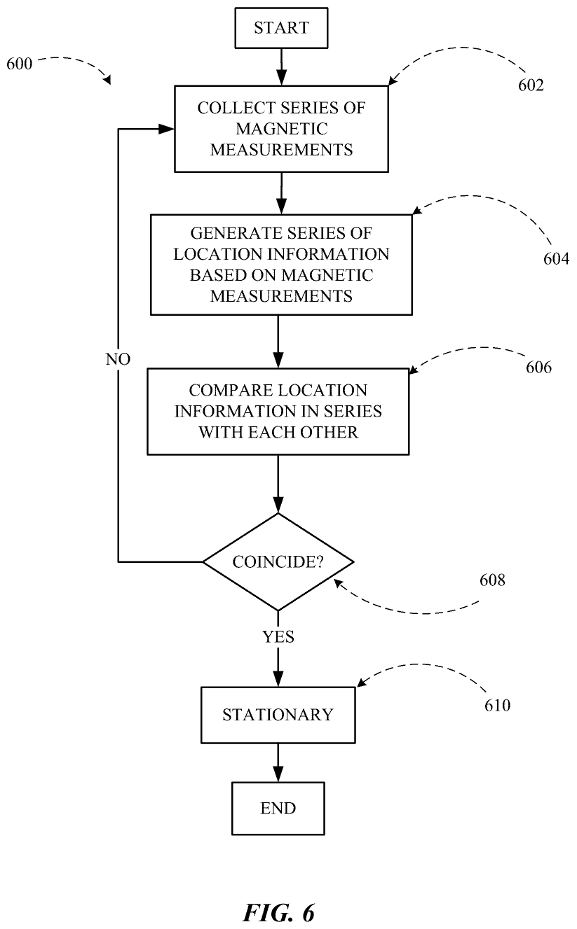

FIG. 6 illustrates another example method 600 for determining whether a device's location or orientation has not changed. Method 600 begins at step 602, where magnetic-sensor system 202 collects a series of magnetic measurements. At step 604, a series of location information for device 200 is generated based on the series of magnetic measurements. As described above, magnetic-sensor system 202 may determine location information for device 200 using one or more apparatuses, systems, or methods disclosed in U.S. Pat. No. 11,428,532, entitled Generating a Geomagnetic Map, U.S. Pat. No. 11,680,802, entitled Correlating Overlapping Magnetic Measurement Data from Multiple Magnetic Navigation Devices and Updating a Geomagnetic Map With That Data, U.S. Pat. No. 11,725,946, entitled Operating Modes of Magnetic Navigation Devices, U.S. Pat. No. 11,719,716, entitled Measuring Distance Traversed or Speed, or U.S. Patent Application Publication No. US 2023/0003544 entitled Embedding a Magnetic Map into an Image File, each of which is incorporated herein by reference in its entirety for all purposes. At step 606, location information at different times in the series is compared with each other. At step 608, if the location information does not coincide with respect to the location or orientation of device 200 (e.g. they are not within a predetermined range of each other and the location or orientation of device 200 changed at those times), then method 600 returns to step 602. At step 608, if the location information coincides with respect to the location or orientation of device 200 (e.g. they are within a predetermined range of each other and the location or orientation of device 200 did not change at those times), then method 600 proceeds to step 610. At step 610, it is determined that device 200 was stationary (e.g. the location or orientation of device 200 did not change) at those times, at which point method 600 ends. In particular embodiments, this determination may be compared with location information from GNSS receiver 206, for example, to determine whether GNSS receiver 206 is being spoofed. If it is determined at step 610 that device 200 was stationary, but information from GNSS receiver 206 indicates that the location or orientation of device 200 changed during that time, then it may be determined that GNSS receiver 206 was being spoofed during that time. When it is determined that GNSS receiver 206 is experiencing or has experienced spoofing, particular embodiments may generate a notification or otherwise report the spoofing to a user of device 200 or to one or more other users or other devices.

Particular embodiments may repeat one or more steps of method 600, where appropriate. Although this disclosure describes and illustrates particular steps of method 600 as occurring in a particular order, this disclosure contemplates any suitable steps of method 600 occurring in any suitable order. Moreover, although this disclosure describes and illustrates an example method for determining whether a device's location or orientation has changed including the particular steps of method 600, this disclosure contemplates any suitable method for determining whether a device's location or orientation has changed including any suitable steps, which may include all, some, or none of the steps of method 600, where appropriate. Furthermore, although this disclosure describes and illustrates particular components, devices, or systems carrying out particular steps of method 600, this disclosure contemplates any suitable combination of any suitable components, devices, or systems carrying out any suitable steps of method 600.

In particular embodiments, magnetic measurements (e.g. by magnetic-sensor system 202) may be used to determine an orientation of device 200. As described above, location information (including orientation) from magnetic-sensor system 202 may be generated or determined using one or more apparatuses, systems, or methods disclosed in U.S. Pat. No. 11,428,532, entitled Generating a Geomagnetic Map, U.S. Pat. No. 11,680,802, entitled Correlating Overlapping Magnetic Measurement Data from Multiple Magnetic Navigation Devices and Updating a Geomagnetic Map With That Data, U.S. Pat. No. 11,725,946, entitled Operating Modes of Magnetic Navigation Devices, or U.S. Pat. No. 11,719,716, entitled Measuring Distance Traversed or Speed, U.S. Patent Application Publication No. US 2023/0003544 entitled Embedding a Magnetic Map into an Image File; U.S. Patent Application No. 63/531,316, filed 8 Aug. 2023, entitled Using Magnetic-Sensor Data for Authentication and Correcting for INS Drift; U.S. Patent Application No. 63/542,292, filed 4 Oct. 2023, entitled Detecting and Correcting for Location Drift in PNT Systems; U.S. patent application Ser. No. 18/795,375, filed 6 Aug. 2024, entitled Using a Magnetic Recording for Authentication; U.S. patent application Ser. No. 18/795,387, filed 6 Aug. 2024, entitled Using Magnetic-Sensor Data to Correct for INS Drift; U.S. patent application Ser. No. 18/795,405, filed 6 Aug. 2024, entitled Determining Confidence in Magnetic-Sensor Data; U.S. patent application Ser. No. 18/795,420, filed 6 Aug. 2024, entitled Determining Movement in an Opposite Direction; or U.S. patent application Ser. No. 18/795,431, filed 6 Aug. 2024, entitled Authenticating a Device Using Geofencing Data, each of which is incorporated herein by reference in its entirety for all purposes. In particular embodiments, when the orientation of device 200 is determined, the orientation may be recorded by device 200 for subsequent use by device 200, another device, or a user of device 200 or the other device. In addition or as an alternative, the orientation may be communicated to one or more components or systems of device 200 (or another device) for use in one or more operations of device 200 (or the other device). In addition or as an alternative, the orientation may be reported to a user of device 200 (or another device), e.g., through a visual display or other indicator to the user.

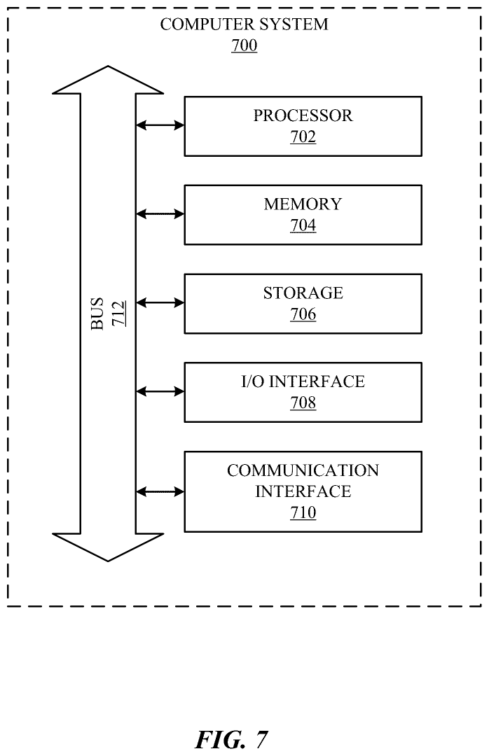

FIG. 7 illustrates an example computer system 700. In articular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may include a computing device, and vice versa, where appropriate. Moreover, reference herein to a computer system may include one or more computer systems, where appropriate. With reference to FIG. 2, a device 200 may include one or more computer systems 700 (or one or more components of a computer system 700).

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a PDA, a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more ALUs; be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include an HDD, a floppy disk drive, flash memory, an optical disc, a magneto-optical disc, magnetic tape, or a USB drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes ROM. Where appropriate, this ROM may be mask-programmed ROM, PROM, EPROM, EEPROM, EAROM, or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a LAN, a WAN, a MAN, or one or more portions of the Internet or a combination of two or more of these. One or more portions of one or more of these networks may be wired or wireless. As an example, computer system 700 may communicate with a WPAN (such as, for example, a BLUETOOTH WPAN), a WI-FI network, a WIMAX network, a cellular telephone network (such as, for example, a GSM network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other ICs (such, as for example, field-programmable gate arrays (FPGAs) or application-specific ICs (ASICs)), HDDs, hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure includes all changes, substitutions, variations, alterations, and modifications to the example embodiments described or illustrated herein that a person having ordinary skill in the art would comprehend. The scope of this disclosure is not limited to the example embodiments described or illustrated herein. The embodiments disclosed herein are only examples, and the scope of this disclosure is not limited to them. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Particular embodiments may include all, some, or none of the components, elements, features, functions, operations, or steps of the embodiments disclosed herein. Furthermore, reference in the appended claims to an apparatus or system or a component of an apparatus or system being adapted to, arranged to, capable of, configured to, enabled to, operable to, or operative to perform a particular function includes that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
by an electronic device, accessing a series of magnetic values measured by a magnetic-measurement device over a predetermined period of time;
by the electronic device, based on the series of magnetic values, determining that a location or orientation of the magnetic-measurement device did not substantially change during the predetermined period of time.

2. (canceled)

3. The method of claim 1, wherein determining that the location or orientation of the magnetic-measurement device did not substantially change during the predetermined period of time comprises:
calculating a variance in the magnetic values over the predetermined period of time;
comparing the variance with a predetermine range of values; and
when the variance is within the predetermine range of values, determining that the location or orientation of the magnetic-measurement device did not substantially change during the predetermined period of time.

4. The method of claim 3, wherein the variance comprises a squared deviation from a mean of the series of magnetic values.

5. (canceled)

6. The method of claim 3, wherein calculating the variance comprises calculating one or more difference or distance calculations.

7. The method of claim 3, wherein the variance is calculated using a nearest centroid classifier, correlation optimized warping (COW), dynamic time warping (DTW), or one or more similarity correlation analyses.

8. The method of claim 1, further comprising:
by the electronic device, accessing location information from a Global Navigation Satellite System (GNSS) receiver, an inertial navigation system (INS), or a communication interface associated with the magnetic-measurement device during the predetermined period of time;
by the electronic device, comparing the location information with the determination that the location or orientation of the magnetic-measurement device did not substantially change;
by the electronic device, when the location information does not substantially coincide with the determination:
updating at least some of the location information to coincide with the determination; or
determining that the GNSS receiver, INS, or communication interface was spoofed and reporting the spoofing to a user, a hardware or software component of the electronic device, or another device.

9. The method of claim 8, wherein updating at least some of the location information to coincide with the determination comprises:
updating at least some of the location information to indicate that the location or orientation of the magnetic-measurement device did not substantially change during the predetermined period of time; or
updating at least some of the location information to coincide with one or more locations or orientations indicated by one or more of the magnetic values.

10. The method of claim 9, wherein updating at least some of the location information comprises:
calculating a spatial midpoint between or among two or more locations indicated by at least some of the magnetic values; and
updating at least some of the location information to coincide with the spatial midpoint.

11. (canceled)

12. The method of claim 1, wherein each of the magnetic values comprises one or more of a total value of a magnetic field, an inclination angle of the magnetic field, a declination angle of the magnetic field, an x component of the magnetic field, a y component of the magnetic field, or a z component of the magnetic field or a magnetic-susceptibility or magnetic-conductivity value.

13. (canceled)

14. (canceled)

15. (canceled)

16. (canceled)

17. The method of claim 1, wherein the electronic device is the magnetic-measurement device.

18. The method of claim 1, wherein the magnetic-measurement device is a vehicle, a robot, or a handheld device.

19. One or more computer-readable non-transitory storage media embodying software that is operable when executed to:
access a series of magnetic values measured by a magnetic-measurement device over a predetermined period of time;
based on the series of magnetic values, determine that a location or orientation of the magnetic-measurement device did not substantially change during the predetermined period of time.

20. (canceled)

21. The media of claim 19, wherein determining that the location or orientation of the magnetic-measurement device did not substantially change during the predetermined period of time comprises:
calculating a variance in the magnetic values over the predetermined period of time;
comparing the variance with a predetermine range of values; and
when the variance is within the predetermine range of values, determining that the location or orientation of the magnetic-measurement device did not substantially change during the predetermined period of time.

22. The media of claim 21, wherein the variance comprises a squared deviation from a mean of the series of magnetic values.

23. (canceled)

24. (canceled)

25. (canceled)

26. The media of claim 19, wherein the software is further operable when executed to:
access location information from a Global Navigation Satellite System (GNSS) receiver, an inertial navigation system (INS), or a communication interface associated with the magnetic-measurement device during the predetermined period of time;
compare the location information with the determination that the location or orientation of the magnetic-measurement device did not substantially change;
when the location information does not substantially coincide with the determination:
update at least some of the location information to coincide with the determination; or
determine that the GNSS receiver, INS, or communication interface was spoofed and reporting the spoofing to a user, a hardware or software component of the electronic device, or another device.

27. The media of claim 26, wherein updating at least some of the location information to coincide with the determination comprises:
updating at least some of the location information to indicate that the location or orientation of the magnetic-measurement device did not substantially change during the predetermined period of time; or
updating at least some of the location information to coincide with one or more locations or orientations indicated by one or more of the magnetic values.

28. The media of claim 27, wherein updating at least some of the location information comprises:
calculating a spatial midpoint between or among two or more locations indicated by at least some of the magnetic values; and
updating at least some of the location information to coincide with the spatial midpoint.

29. (canceled)

30. The media of claim 19, wherein each of the magnetic values comprises one or more of a total value of a magnetic field, an inclination angle of the magnetic field, a declination angle of the magnetic field, an x component of the magnetic field, a y component of the magnetic field, or a z component of the magnetic field or a magnetic-susceptibility or magnetic-conductivity value.

31. (canceled)

32. (canceled)

33. (canceled)

34. (canceled)

35. The media of claim 19, wherein the magnetic-measurement device comprises the media.

36. The media of claim 19, wherein the magnetic-measurement device is a vehicle, a robot, or a handheld device.

37. A system comprising:
one or more processors; and
one or more computer-readable non-transitory storage media coupled to one or more of the processors and comprising instructions operable when executed by one or more of the processors to cause the system to:
access a series of magnetic values measured by a magnetic-measurement device over a predetermined period of time;
based on the series of magnetic values, determine that a location or orientation of the magnetic-measurement device did not substantially change during the predetermined period of time.

38. (canceled)

39. The system of claim 37, wherein determining that the location or orientation of the magnetic-measurement device did not substantially change during the predetermined period of time comprises:
calculating a variance in the magnetic values over the predetermined period of time;
comparing the variance with a predetermine range of values; and
when the variance is within the predetermine range of values, determining that the location or orientation of the magnetic-measurement device did not substantially change during the predetermined period of time.

40. The system of claim 39, wherein the variance comprises a squared deviation from a mean of the series of magnetic values.

41. (canceled)

42. (canceled)

43. (canceled)

44. The system of claim 37, wherein the software is further operable when executed to:
access location information from a Global Navigation Satellite System (GNSS) receiver, an inertial navigation system (INS), or a communication interface associated with the magnetic-measurement device during the predetermined period of time;
compare the location information with the determination that the location or orientation of the magnetic-measurement device did not substantially change;
when the location information does not substantially coincide with the determination:
update at least some of the location information to coincide with the determination; or
determine that the GNSS receiver, INS, or communication interface was spoofed and reporting the spoofing to a user, a hardware or software component of the electronic device, or another device.

45. The system of claim 44, wherein updating at least some of the location information to coincide with the determination comprises:
updating at least some of the location information to indicate that the location or orientation of the magnetic-measurement device did not substantially change during the predetermined period of time; or
updating at least some of the location information to coincide with one or more locations or orientations indicated by one or more of the magnetic values.

46. The system of claim 45, wherein updating at least some of the location information comprises:
calculating a spatial midpoint between or among two or more locations indicated by at least some of the magnetic values; and
updating at least some of the location information to coincide with the spatial midpoint.

47. (canceled)

48. The system of claim 37, wherein each of the magnetic values comprises one or more of a total value of a magnetic field, an inclination angle of the magnetic field, a declination angle of the magnetic field, an x component of the magnetic field, a y component of the magnetic field, or a z component of the magnetic field or a magnetic-susceptibility or magnetic-conductivity value.

49. (canceled)

50. (canceled)

51. (canceled)

52. (canceled)

53. The system of claim 37, wherein the magnetic-measurement device is the system.

54. The system of claim 37, wherein the magnetic-measurement device is a vehicle, a robot, or a handheld device.

55. A system comprising:
means for accessing a series of magnetic values measured by a magnetic-measurement device over a predetermined period of time;
means for, based on the series of magnetic values, determining that a location or orientation of the magnetic-measurement device did not substantially change during the predetermined period of time.
